(19) United States
(12) Patent Application Publication
(10) Pub. No.: US 2017/0244876 A1
(43) Pub. Date: Aug. 24, 2017

(54) IMAGE PROCESSING APPARATUS, IMAGE CAPTURING APPARATUS, AND IMAGE PROCESSING PROGRAM

(71) Applicant: CANON KABUSHIKI KAISHA, Tokyo (JP)

(72) Inventors: Yoshiaki Ida, Utsunomiya-shi (JP); Chiaki Inoue, Utsunomiya-shi (JP); Yuichi Kusumi, Utsunomiya-shi (JP)

(21) Appl. No.: 15/434,422

(22) Filed: Feb. 16, 2017

(30) Foreign Application Priority Data
Feb. 23, 2016 (JP) 2016-031968

(51) Int. Cl. H04N 5/225; G01B 11/25; H04N 5/357; H04N 5/378; G06K 9/52; H04N 5/235

(52) U.S. Cl. CPC H04N 5/2256; G06K 9/52; H04N 5/2352; H04N 5/357; H04N 5/378; G01B 11/25

(57) ABSTRACT

An image processing apparatus includes a generator configured to acquire a plurality of input images generated by image captures under a plurality of light source conditions in which positions of light sources for illuminating an object are different from one another, and to generate normal information on a surface of the object using information on a change of luminance information in the input image which depends on the light source condition, and an acquirer configured to acquire noise reduction process information as information used for a noise reduction process to the normal information or a process target image, using light source information as information on the light source in the image capture. The noise reduction process information contains information used to set an intensity of the noise reduction process.

### BACKGROUND OF THE INVENTION

Field of the Invention

The present invention relates to a technology configured to acquire normal information of an object using an image acquired by image capturing.

Description of the Related Art

There is known a method for acquiring information on a surface normal (referred to as “normal information” hereinafter) as shape information of an object based on an image obtained by capturing an object with an image capturing apparatus, such as a digital camera. The method for acquiring the normal information may utilize a method for converting into the normal information a three-dimensional shape found by distance information obtained through a method, such as the triangulation using a laser beam and the binocular stereo method. Yasuyuki Matsushita, “Photometric Stereo,” Information Processing Society of Japan, The Special Interest Group Technical Reports, Vol. 2011-CVIM-177, No. 29, pp. 1-12, 2011. The photometric stereo method assumes a reflection characteristic based on the surface normal of the object and the light source direction, and determines the surface normal based on the luminance information of the object at a plurality of light source positions and the assumed reflection characteristic. The reflection characteristic of the object often uses a Lambert reflection model that follows the Lambert cosign law.

In general, the reflection on the object is classified into a specular (or mirror) reflection and a diffuse reflection. The specular reflection is a regular reflection on the object surface, and is a Fresnel reflection represented by the Fresnel equations on the object surface (interface). The diffuse reflection is a reflection in which the light transmits through the surface of the object, diffuses inside the object, and returns to the outside of the object. The specular reflected light is not expressed by the Lambert cosign law, and when the reflected light from the object observed in the image capturing apparatus contains the specular reflected light, the photometric stereo method cannot precisely calculate the surface normal. The photometric stereo method causes a shift from the assumed reflected model in a shaded area that receives no light from the object, and cannot precisely acquire the normal information of the object. Moreover, the diffuse reflection component shifts from the Lambert cosign law in an object having a rough surface.

For example, Japanese Patent Laid-Open No. 2010-122158 discloses a method for calculating a true surface normal based on a plurality of normal candidates obtained using four or more light sources. Japanese Patent No. 4,435,865 discloses a method for dividing a diffuse reflection area based on a polarized light flux emitted from the light source or a polarization state when a light source position is changed and for using a photometric stereo method for the diffuse reflection area.

The photometric stereo method acquires the normal information based on the luminance information, and thus may have an error (noise) in the normal information under the influence of the noises contained in the luminance information. Even when a noise amount contained in the luminance information is equal, a noise amount contained in the normal information is different due to the light source condition in the image capturing. An image generated using this normal information (referred to as a “normal utilization image” such as a relighted image corresponding to an image of an object under a virtual light source condition) may have a noise under the influence of the noise in the normal information.

However, each of Japanese Patent Laid-Open No. 2010-122158 and Japanese Patent No. 4,435,865 is silent about a noise reduction process for the normal information. The method disclosed in Japanese Patent Laid-Open No. 2010-122158 uses a different determination method of the surface normal between where the specular reflection component is observed and where the specular reflection component is not observed. Thus, the magnitude of the noise in the normal information scatters for each pixel. When a uniform noise reduction process is performed for all pixels in this state, the residue noises and blurs occur. Each of the methods disclosed in Japanese Patent Laid-Open No. 2010-122158 and Japanese Patent No. 4,435,865 does not consider a change of the noise contained in the normal information which depends on the light projection angle from the light source onto the object. Thus, this configuration cannot perform a proper noise reduction process, causing residue noises or blurs.

### SUMMARY OF THE INVENTION

The present invention provides an image processing apparatus, an image capturing apparatus, and an image processing program, which can generate normal information or a normal utilization image having reduced influences of noises.

An image processing apparatus according to one aspect of the present invention includes a generator configured to acquire a plurality of input images generated by image captures under a plurality of light source conditions in which positions of light sources for illuminating an object are different from one another, and to generate normal information on a surface of the object using information on a change of luminance information in the input image which depends on the light source condition, and an acquirer configured to acquire noise reduction process information as information used for a noise reduction process to the normal information or a process target image, using light source information as information on the light source in the image capture. The noise reduction process information contains information used to set an intensity of the noise reduction process.

Further features of the present invention will become apparent from the following description of exemplary embodiments with reference to the attached drawings.

### BRIEF DESCRIPTION OF THE DRAWINGS

FIG. 1 is a flowchart illustrating image processing performed in an image capturing apparatus according to a first embodiment of the present invention.

FIG. 2 is an overview of the image capturing apparatus according to the first embodiment.

FIG. 3 is a block diagram illustrating a configuration of the image capturing apparatus according to the first embodiment.

FIG. 4 is a view illustrating a relationship between an image sensor and a pupil in an image capturing optical system according to the first embodiment.

FIG. 5 is a schematic view of the image sensor.

FIG. 6 is an overview of another illustrative image capturing apparatus according to the first embodiment.

FIG. 7 is a view of an illustrative data table of a noise amount according to the first embodiment.

FIGS. 8A and 8B are views of a light source projection angle when a short distance object and a long distance object are captured.

FIG. 9 is a flowchart illustrating image processing performed in an image capturing apparatus according to a second embodiment of the present invention.

FIG. 10 is a view for explaining a specular reflection component.

### DESCRIPTION OF THE EMBODIMENTS

A description will be given of a variety of embodiments according to the present invention with reference to the accompanying drawings.

Before a specific embodiment is described, a common matter in each embodiment will be described. Each embodiment relates to an image processing apparatus configured to acquire normal information as information on a surface normal of a surface of an object and an image capturing apparatus mounted with the image processing apparatus, and can effectively reduce the influence of noises contained in the normal information.

The normal information (surface normal information) contains information used to determine at least one candidate having one freedom degree of the surface normal information used to select a true solution from among a plurality of solution candidates of the surface normal, and information on adequacy of the calculated surface normal.

A photometric stereo method may be used for the method for acquiring the normal information of the object based on the luminance information as the information on the luminance of the object (captured image) which depends on the light source position (light source condition). The photometric stereo method assumes a reflection characteristic based on the surface normal of the object and the light source direction, and determines the surface normal based on the luminance information of the object at a plurality of light source positions and the assumed reflection characteristic. The reflectance of the assumed reflection characteristic uniquely determines the reflectance once a certain surface normal and a certain light source position are specified. When the reflection characteristic of the object is unknown, it may be approximated by the Lambert reflection model that follows the Lambert cosign law.

The specular reflection component can be expressed by a model in which the reflectance depends on an angle between a bisector between a light source vector s and a visual axis direction vector v, and a surface normal n. Therefore, the reflection characteristic may be a characteristic based on the visual axis direction. The luminance information used for the photometric stereo method is made by capturing an image when a known light source is turned on and an image when the known light source is turned off, by calculating a difference between these images, and by removing the influence of a light source, such as environmental light, other than the known light source. The Lambert reflection model is assumed in the following description.

Assume that i is the luminance of the reflected light, ρd is a Lambert diffuse reflectance of an object, E is an intensity of incident light, s is a unit vector (light source direction vector) from the object to the light source, and n is a unit surface normal vector of the object. Then, the Lambert cosign law provides the following expression.

i=Eρ_{d}s·n (1)

The following expression is established based on the expression (1) where i₁, i₂, . . . , i_{M} are luminances obtained from M (M≧3) different light source directions s₁, s₂, . . . , S_{M}.

$$[ \begin{matrix}{i}_{1} \\ ⋮ \\ {i}_{M}\end{matrix} ] = [ \begin{matrix}{s}_{1}^{T} \\ ⋮ \\ {s}_{M}^{T}\end{matrix} ] E {ρ}_{d} n \qquad ( 2 )$$

The left side is an M×1 luminance vector, and the right side [s₁^{r}, . . . ′, s_{M}^{T}] is an M×3 incident light matrix S representing the light source direction. In addition, n is a 3×1 unit surface normal vector. Eρdn is found as follows when M=3 by multiplying the inverse matrix of the incident light matrix S from the left.

$$E {ρ}_{d} n = {S}^{- 1} [ \begin{matrix}{i}_{1} \\ ⋮ \\ {i}_{M}\end{matrix} ] \qquad ( 3 )$$

The norm of the left side vector is a product of E and ρd, and a normalized vector is found as a surface normal vector of the object. As understood, E and ρd appear as the product in the conditional expression, and the conditional expression can be regarded as simultaneous expressions that determines three unknown variables with two freedom degrees of the unit surface normal once Eρd is regarded as one variable. Thus, the three equations are obtained by obtaining the luminance information under the three light source conditions, and a solution can be determined. When the incident light matrix S is not a regular matrix, the inverse matrix does not exist, and it is necessary to select the light source directions s₁ to s₃ so that the incident light matrix S can be regular. In other words, it is necessary to select s₃ so that s₃ is linearly independent of s₁ and s₂.

On the other hand, when M>3, conditional expressions more than the number of unknown variables to be found are obtained. At that time, the surface normal can be obtained by the method similar to the above method with three arbitrarily selected conditional expressions. When four or more conditional expresses are used, the incident light matrix S is not a square matrix and thus a Moore-Penrose pseudo inverse matrix may be used for the approximation solution, for example.

The solution may be calculated by a known fitting method or an optimization method even when the matrix calculation is not used. In particular, the reflection characteristic of the object is assumed by a model other than the Lambert reflection model, the conditional expression may not be a linear equation to a known coefficient of the reflection characteristic model and each component in the unit surface normal vector n. In this case, the matrix cannot be calculated and the solution is calculated by the known fitting method and optimization method. As described, the reflection characteristic model f is expressed as follows with the light source vector s, the visual axis direction vector v, the surface normal n, and the known coefficient X.

i=f(s,v,n,X) (4)

Herein, X is a coefficient vector of a reflection characteristic model, and has the same dimension as that of the number of coefficients. When m coefficients are unknown, the expression (4) contains (m+2) unknown variables including the surface normal vector. At this time, equations by the number of conditional expressions of the light source positions are obtained, and the known fitting method and the optimization method can be used. For example, the following expression may be minimized.

$$Err = {\sum }_{j = 1}^{M} \{ {i}_{j} - f ( {s}_{j} , {v}_{j} , n , X ) \} \qquad ( 5 )$$

When the reflection characteristic model f depends on the viewing direction vector v, the number of equations can be increased by changing the visual axis direction.

When the solution is obtained from (M−1) equations or less, the solution can be obtained by the combination number of conditional expressions and a plurality of surface normal candidates can also be calculated. In this case, the solution may be selected by the method in Japanese Patent Laid-Open No. 2010-122158 or the following method.

An image area in which the normal information cannot be properly acquired or estimated by the photometric stereo method may be a shaded area that cannot receive the light from the light source due to shielding and an area in which a specular reflection component or an interreflection component is observed in the reflection characteristic model where an observation of the diffuse reflection component is assumed. In this case, the normal information may be estimated by excluding the luminance information obtained at the light source position that causes the shaded area and the area in which the non-assumed reflection component is observed. Whether the light source position is inappropriate in acquiring the certain luminance information may be determined by using a method for extracting the known shaded area and specular reflection area, such as the threshold processing of the luminance information.

The photometric stereo method determines the surface normal based on the luminance information, and thus may have an error or noise in the normal information acquired under the influence of the noises contained in the luminance information. Moreover, even when a noise amount contained in the luminance information is equal, a noise amount contained in the normal information is different according to the light source condition in the image captures of the plurality of images. Therefore, the normal utilization image (such as a relighted image described later) generated by using the normal information may contain noises.

When a plurality of solution candidates of the surface normal vectors are calculated, a solution may be selected based on another condition. For example, a continuity of the surface normal vector may be used for the condition. Where the surface normal is calculated for each pixel in the image capturing apparatus and n(x,y) is a surface normal on a pixel (x,y), the solution is selected that minimizes the following evaluation function when n(x−1,y) is known.

1−n(x,y)·n(x−1,y) (6)

The solution that minimizes the following expression may be selected when n(x+1,y) and n(x,y+1) are known.

4−n(x,y)·n(x−1,y)−n(x,y)·n(x+1,y)−n(x,y)·n(x,y−1)−n(x,y)·n(x,y+1) (7)

When there is no known surface normal or the surface normal has uncertainty at all pixel positions, the solution may be selected that minimizes the following expression that is a total sum of all pixels.

$${\sum }_{x , y} \{ 4 - n ( x , y ) \cdot n ( x - 1 , y ) - n ( x , y ) \cdot n ( x + 1 , y ) - n ( x , y ) \cdot n ( x , y - 1 ) - n ( x , y ) \cdot n ( x , y + 1 ) \} \qquad ( 8 )$$

The present invention is not limited to the above example, and may use surface normal information at a pixel other than the pixel closest to the target pixel or may use an evaluation function weighted according to a distance from the position of the target pixel.

When the solution is selected from among the plurality of candidates, depth information may be used. The depth information can be acquired by the method, such as the binocular stereo and the triangulation using the laser beam. The surface normal vector can be calculated by converting the three-dimensional shape calculated from the depth information into the surface normal information. As described above, the surface normal vector calculated by this method has insufficient precision. However, when a plurality of solution candidates of surface normal vectors have already been calculated, this surface normal vector can be used as reference information to determine one solution. In other words, the candidate that is closest to the surface normal vector calculated by the depth information may be selected among the plurality of solution candidates of surface normal vectors.

The luminance information may be used at an arbitrary light source position. For example, in the Lambert reflection model, the luminance of the reflected light becomes higher as the surface normal vector is closer to the light source direction. Thus, by referring to luminance values in the plurality of light source directions, the surface normal vector can be selected that is closer to the light source direction that provides a high luminance than the light source direction that provides a low luminance. The following expression is established on a smooth surface in the specular reflection model and the surface normal n can be calculated where v is a unit vector from the object to the camera (viewing direction vector in the camera), and the light source direction vector s and the visual axis direction v of the camera are known.

s+v=2(v·n)n (9)

In a general object having a rough surface, the specular reflection has a spread of the exit angle, but it spreads near the solution calculated on the assumption of the smooth surface. Thus, the candidate that is closest to the solution to the smooth surface can be selected among the plurality of solution candidates. In addition, a true solution may be determined by averaging the plurality of solution candidates.

The image processing apparatus according to each embodiment acquires a plurality of input images (captured images) generated by image captures under a plurality of light source conditions in which positions of the light sources for illuminating the object are different from one another. The normal information of the surface of the object is generated using luminance change information as information on a change of the luminance in the input image which depends on the light source condition. Moreover, noise reduction process information is acquired as information used for the noise reduction process to normal information or a process target image (image to be processed), using light source information as information on the light source in the image capture. The noise reduction process information contains, for example, information used to set an intensity of the noise reduction process.

This method can acquire the normal information based on the luminance change information that depends on the light source position, by acquiring a plurality of input images in which the light source positions (light source conditions) are different from one another. The normal information has a value having at least one freedom degree of the surface normal. The noise difference can be obtained by acquiring the light source information, when the normal information depending on the light source information is acquired. Thus, the noise influence contained in the normal information can be effectively reduced by acquiring the noise reduction process information that depends on this noise difference (in other words, the light source information).

In each embodiment, the light source information may contain information on the light projection direction from the light source to the object. More specifically, the information on the light projection direction may contain the information on an angle between an image capturing direction from the image capturing apparatus that provides the image capture to the object and the light projection direction, and information on an angle between the light projection directions from the plurality of light sources. In the following description, these angles will be collectively referred to as a light source projection angle.

As described above, the light source direction in the photometric stereo method may be selected so that they are linearly independent of one another. In addition to the linear independence, the normal acquisition precision becomes higher and a change of the luminance information increases, as the angle between different light source directions becomes higher. On the contrary, as the angle between the different light source directions decreases, a change of the luminance information decreases and the luminance information is more subject to the noise influence contained in the input image. At this time, an error increases in the acquired normal. The proper noise reduction process can be performed by acquiring the noise reduction process information that depends on the light source projection angle in the input image. In an attempt to increase the angle between the light source directions, the image capturing apparatus becomes larger and the shaded area is likely to occur. Moreover, the light source projection angle also depends on the relationship between the object and the light source position. It is thus necessary to perform a proper noise reduction process for the light source projection angle determined by these factors.

The light source projection angle can be acquired based on information on the object distance in the image capture for acquiring the input image. In this case, for example, the object distance may be measured in the image capture, or the object distance may be estimated based on the focus lens position in the image capturing optical system. A plurality of parallax images having mutually different parallaxes may be acquired, and the object distance may be estimated based on the parallax images. The parallax image can be acquired by introducing the plurality of light fluxes that have passed mutually different areas in the pupil in the image capturing optical system, to mutually different pixels in the image sensor, and by photoelectrically converting the light fluxes there. The “mutually different pixels” as used herein may be a plurality of sub pixels in the image sensor in which each pixel includes one micro lens and the plurality of sub pixels.

In each embodiment, the light source information may contain information on the number of light source conditions used to estimate the normal information. The information on the number of light source conditions, as used herein, may contain, for example, information on the number of input images corresponding to the number of light source conditions. In order to correctly estimate the normal information by the photometric stereo method, the normal information can be estimated from the residue input images after the input image (or the light source condition) in which the shaded area or the specular reflection area has been observed is excluded. In this case, the number of input images that can be used to estimate the normal information depends on whether the light source condition is excluded and the number of excluded light source conditions. This means changing the number of conditional expressions used to estimate the normal information. As the number of conditional expressions used to estimate the normal information or the number of input images reduces, the acquisition precision of the input image is more subject to the noise influence and the resultant normal information contains more noises. The proper noise reduction process can be performed by acquiring the noise reduction process information depending on the number of input images (or the number of light source conditions) used to estimate the normal information.

When the number of input images used to estimate the light source projection angle and the normal information is different for each partial area (pixel) on the object, the noise reduction process information may be acquired for each partial area on the object.

The image processing apparatus or the image capturing apparatus according to each embodiment may perform the noise reduction process for the normal information or the process target image using the noise reduction process information. The noise reduction process to the normal information can reduce noises by considering the method and condition when the normal information is estimated from the input image. The noise reduction process to the normal information may be performed by the known method, and the known noise reduction process may be performed, for example, by considering each freedom degree value of the normal information to be equivalent with the luminance value of the image. In addition, by performing the noise reduction process for the input image as the process target image, the noise reduction process may be performed based on the luminance value of the input image as primary data. Moreover, the noise reduction process may be performed for the normal utilization image as the process target image, which is generated by image processing using the normal information. The normal utilization image may contain, for example, a relighted image generated by image processing using the normal information, as the object image under the virtual light source condition. The normal utilization image in which noises are well reduced can be obtained by performing the noise reduction process for the relighted image as the output image, irrespective of the estimation method of the normal information and its condition, and the generating method of the relighted image and its condition.

### First Embodiment

FIG. 2 illustrates an overview of an image capturing apparatus 300 according to a first embodiment of the present invention. The image capturing apparatus 300 includes an image capturing unit 100 configured to capture an image of an unillustrated object, and a plurality of (sixteen) light sources 200 around an image capturing optical system 101 as an optical system for the image capturing unit 100. The sixteen light sources 200 include two sets of light sources 200 differently distant from the optical axis (light source positions) in the image capturing optical system 101 where each one set of light sources 200 includes eight light sources symmetrically arranged around the optical axis in the up, down, left, right, and oblique directions and equally distant from the optical axis. A plurality of light source positions to the object can be obtained by selectively turning on one or two or more light sources 200 among the sixteen light sources 200.

The number and arrangement of the light sources 200 illustrated in FIG. 2 are merely illustrative, and more or less than sixteen light sources may be arranged differently from those illustrated in FIG. 2. Since the photometric stereo method needs at least three light sources, it is necessary to provide three or more light sources. A plurality of (three or more) light source positions may be selected by changing a position of a single light source. Moreover, this embodiment includes the light source in the image capturing apparatus 300 but may use a light source externally attached to the image capturing apparatus.

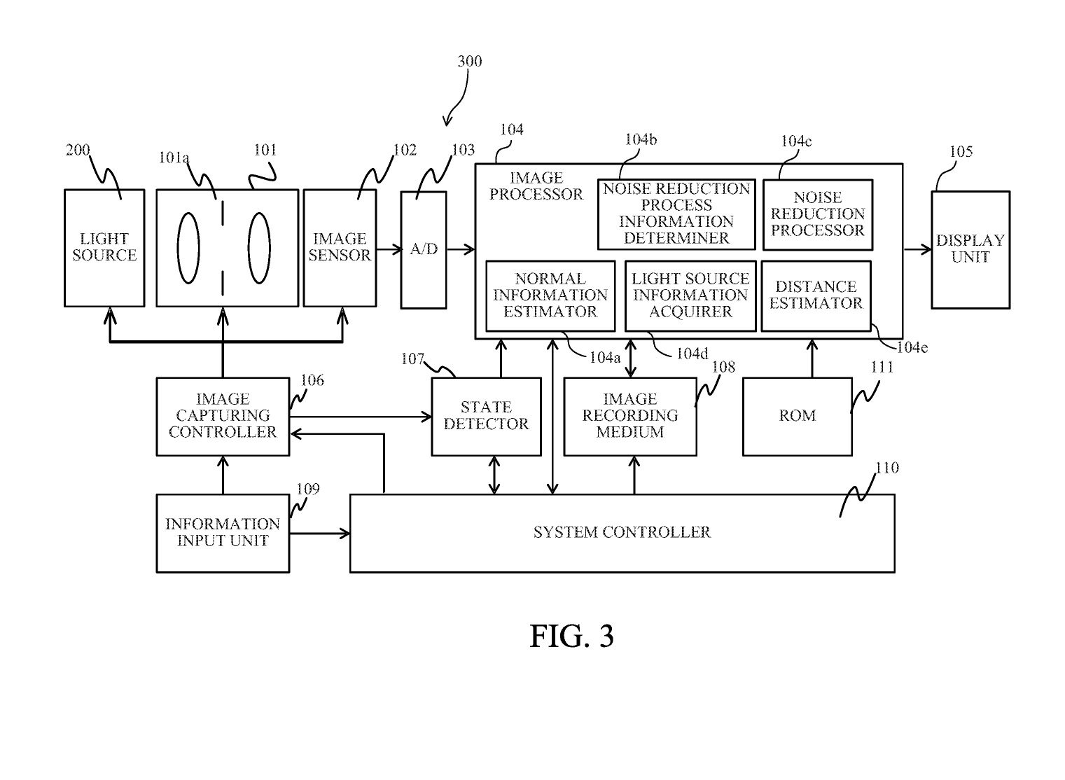

FIG. 3 illustrates an internal configuration in the image capturing apparatus 300. The image capturing unit 100 includes the image capturing optical system 101 and the image sensor 102. The image capturing optical system 101 includes a diaphragm (aperture stop) 101a and images the light from the unillustrated object on the image sensor 102. The image sensor 102 includes a photosensitive conversion element, such as a CCD sensor and a CMOS sensor, and photoelectrically converts (captures) an object image as an optical image formed by the image capturing optical system 101.

An analog signal output from the image sensor 102 is converted into a digital signal by an A/D converter 103, and an image signal as the digital signal is input into an image processor 104 as an image processing apparatus. The image processor 104 generates an image by performing general image processing for the image signal. The image processor 104 includes a normal information estimator (generator) 104a configured to estimate (generate or obtain) normal information of the object using an input image, where a plurality of images generated by image captures in which positions of the light sources 200 for illuminating the object are different from one another are set to the input image. The image processor 104 further includes a noise reduction process information determiner (acquirer) 104b configured to determine (acquire) noise reduction process information according to light source information, and a noise reduction processor 104c configured to perform a noise reduction process using the noise reduction process information. The image processor 104 further includes a light source information acquirer 104d configured to acquire the light source information based on information from a state detector 107, which will be described later, and a distance estimator 104e configured to estimate a distance (object distance) to the object in the image capture.

The output image generated by the image processor 104 (such as a relighted image after the noise reduction process is performed) is stored in an image recording medium 108, such as a semiconductor memory and an optical disc. The output image may be displayed on a display unit 105.

The information input unit 109 selects an image capturing condition desired by the user, such as an F-number, an exposure time period, an ISO speed, and a light source condition, detects input information, and supplies the data to a system controller 110. The image capturing controller 106 moves the unillustrated focus lens in the image capturing optical system 101 for focusing on the object in accordance with a command from the system controller 110, and controls the light source 200, the diaphragm 101a, and the image sensor 102 for image captures.

The state detector 107 detects information of the state of the image capturing optical system 101, such as the position of the focus lens, the F-number, the position of the magnification varying lens when the image capturing optical system 101 is configured to provide a variable magnification, the position of the illuminating light source 200, and the light emission intensity, and sends the data to the system controller 110. The image capturing optical system 101 may be integrated with the image capturing apparatus body that includes the image sensor 102 or may be interchangeable from the image capturing apparatus body.

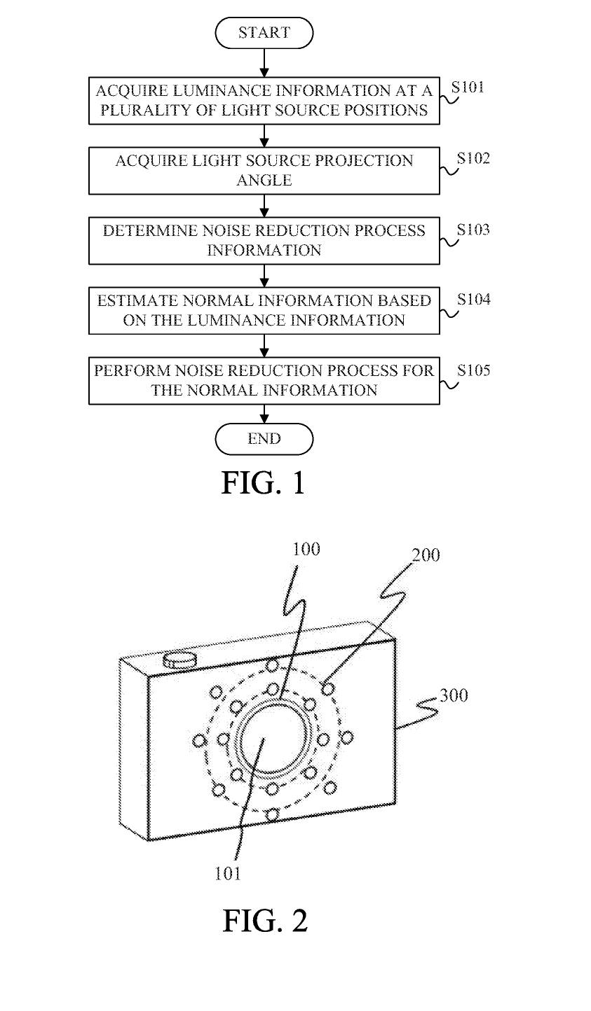

A flowchart in FIG. 1 illustrates a flow of image processing that includes the estimation process of the normal information and the noise reduction process, which is performed by the system controller 110 and the image processor 104. Each of the system controller 110 and the image processor 104 may be configured as a computer that can execute this image processing in accordance with an image processing program as a computer program. This is true of another embodiment, which will be described later. This image processing may be executed by software or a hardware circuit.

In the step S101, the system controller 110 controls the image capturing unit 100 that includes the image capturing optical system 101 and the image sensor 102, and captures the object at a plurality of light source positions. At this time, the system controller 110 selects the illuminating light source 200 via the image capturing controller 106 (or the light source position), and controls the light emission intensity of the selected light source(s) 200. The image processor 104 generates a plurality of images based on the image signal output from the image sensor 102 by the image captures at the plurality of light source positions. The image processor 104 acquires the luminance information of the plurality of images (input images).

Next, in the step S102, the image processor 104 (light source information acquirer 104d) acquires a light source projection angle as the light source information. At this time, the image processor 104 acquires the light source position through the state detector 107, and acquires the relative positions among the image capturing optical system 101, the image sensor 102, and the light source. Thus, the light source projection angle can be acquired by acquiring the information representing the position of the object. The information representing the position of the object can be obtained based on the position of the object in the image and the object distance in the image capture.

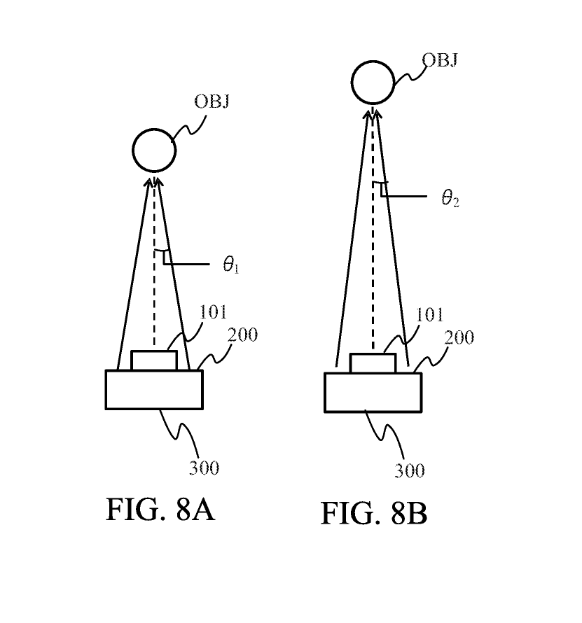

FIGS. 8A and 8B illustrate light source projection angles θ1 and θ2 when an object OBJ is located at a short distance position and a long distance position. Even when the light source is installed in the image capturing apparatus 300, and the image capturing optical system 101 and the light source 200 have relative fixed positions, the light source projection angles θ1 and θ2 are different according to the object distance as illustrated in these figures.

The distance estimator 104e estimates the object distance based on the position of the focus lens when the autofocus or manual focus by the user provides an in-focus state on the object in the image capture in the step S101. The distance estimator 104e may acquire a plurality of parallax images having mutual parallaxes captured at different viewpoints, and estimate the object distance based on these parallax images. More specifically, the object distance (depth) can be estimated by the triangulation method based on the parallax amounts at corresponding points of the object in the plurality of parallax images, positional information at each viewpoint, and the information of the focal length of the image capturing optical system 101. The object distance used to acquire the information representing the position of the object may be an average value of object distances estimated at the plurality of corresponding points of the object or the object distance at a specified point on the object.

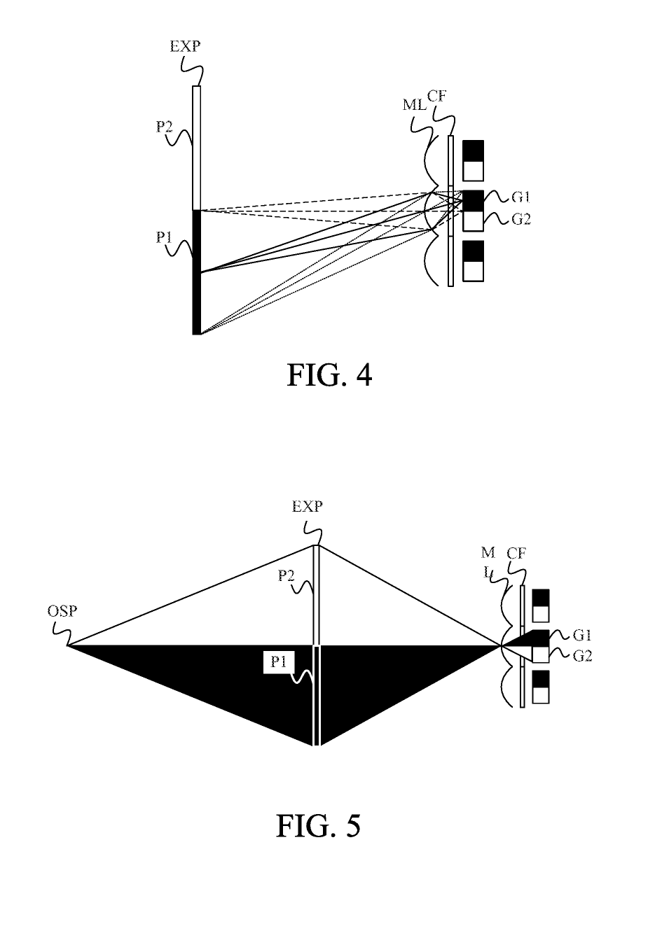

In estimating the object distance based on the plurality of parallax images, a plurality of light fluxes that have passed mutually different areas in the pupil in the image capturing optical system 101 may be guided to mutually different pixels in the image sensor 102 (or the plurality of sub pixels in each pixel). FIG. 4 illustrates a relationship between the image sensor 102 having a pair of (two) sub pixels for each pixel and the pupil in the image capturing optical system 101. In FIG. 4, ML denotes a micro lens, and CF denotes a color filter. EXP denotes an exit pupil in the image capturing optical system 101. G1 and G2 denote a pair of sub pixels as light receiving parts (photoelectric converters) in one pixel. In the following description, a pair of sub pixels will be referred to as a G1 pixel and a G2 pixel.

A plurality of pixels each having the G1 pixel and G2 pixel are arranged on the image sensor 102. The G1 pixel and the G2 pixel have a conjugate relationship with the exit pupil EXP via a common micro lens ML (which is provided for each sub pixel pair). In the following description, a plurality of G1 pixels arranged in the image sensor 102 will be collectively referred to as a G1 pixel group and a plurality of G2 pixels arranged in the image sensor 102 will be collectively referred to as a G2 pixel group.

FIG. 5 schematically illustrates the image capturing unit 100 where a thin lens is located at the position of the exit pupil EXP instead of the micro lens ML illustrated in FIG. 4. The G1 pixel receives the light that has passed a P1 area in the exit pupil EXP, and the G2 pixel receives the light that has passed a P2 area in the exit pupil EXP. OSP is an object point to be captured. The object point OSP does not always have an object, and the light flux that has passed this point enters the G1 pixel and the G2 pixel according to the passage area (position) in the pupil. Passing of the light fluxes at different areas in the pupil corresponds to separating the incident light based on the object point OSP according to the angle (parallax). In other words, among the G1 and G2 pixels provided for each micro lens ML, an image generated with the output signal from the G1 pixel and an image generated with the output signal from the G2 pixel form a plurality of (a pair of in this embodiment) parallax images having mutual parallaxes. In the following description, a pupil division may mean that the different light receivers (sub pixels) receive the light fluxes that have passed mutually different areas in the pupil.

In FIGS. 4 and 5, when the above conjugate relationship destroys due to a positional shift of the exit pupil EXP or when the P1 area and the P2 area partially overlap each other, the obtained plurality of images can be treated as the parallax images.

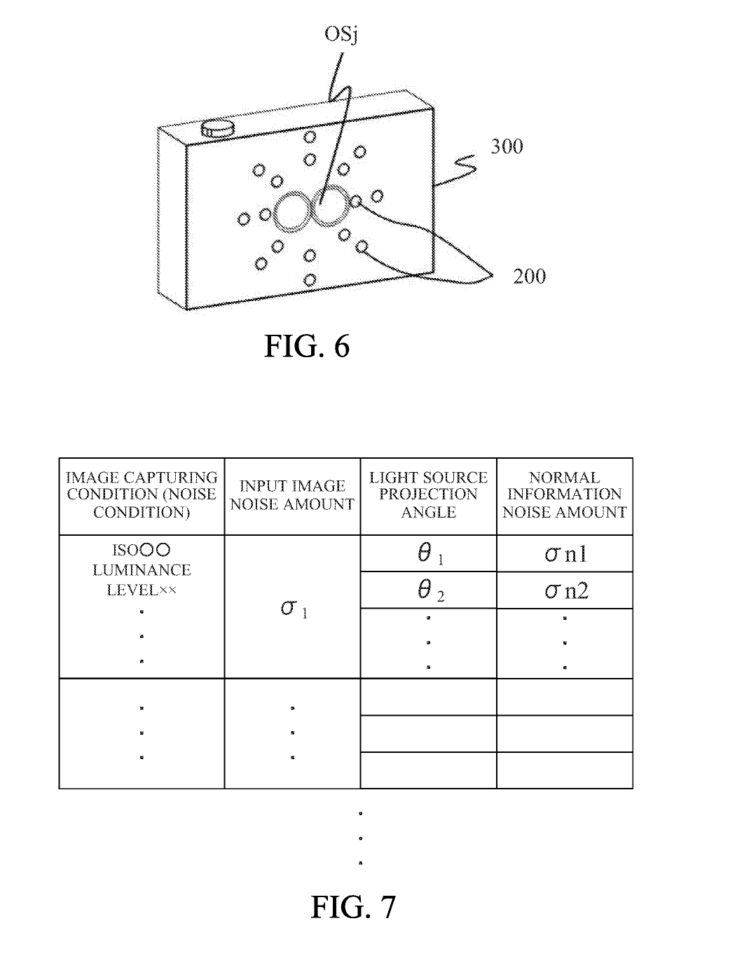

In another example, as illustrated in FIG. 6, when one image capturing apparatus 301 includes a plurality of image capturing optical systems OSj (j=1, 2) in which optical axes are spaced, the parallax images can be obtained.

Next, in the step S103, the image processor 104 (noise reduction process information determiner 104b) determines the noise reduction process information based on the light source projection angle acquired in the step S102. The noise reduction process information uses normal information noise amount σn as a noise amount contained in the normal information. The noise amount is a standard deviation of a noise distribution, and the normal information noise amount on represents a noise amount for a value of each freedom degree of the normal.

A noise condition is defined as a noise related condition for an input image, such as the ISO speed of the image capturing apparatus (image sensor 102) and the luminance level of the input image in the image capturing condition acquired by the state detector 107. At this time, a ROM 111 illustrated in FIG. 3 stores previously measured data of the normal information noise amount σn to various light source projection angles under a certain noise condition. The noise reduction process information determiner 104b acquires the normal information noise amount σn corresponding to the actual light source projection angle from the ROM 111 in determining the noise reduction process information.

The normal information noise amount σn corresponding to each of a variety of noise conditions may be stored in the ROM 111, and the normal information noise amount σn corresponding to the actual noise condition and the light source projection angle may be acquired from the ROM 111. Moreover, the normal information noise amount σn may be stored in the ROM 111 for each input image noise amount σi as the noise amount contained in the input image, and the normal information noise amount σn corresponding to the input image noise amount σi in the image capture may be acquired from the ROM 111. The input image noise amount σi may be stored in the ROM 111 for each noise condition, and calculated with the MAD (Median Absolute Deviation).

The MAD is calculated by the following expression (10) using a wavelet coefficient w_{HH1} of the highest frequency sub band image HH1 acquired by wavelet-converting the image.

MAD=median(|w_{HH1}−median(w_{HH1})|) (10)

The input image noise amount σi contained in the captured image can be estimated from the relationship expressed by the following expression (11) between the MAD and the standard deviation.

σi=MAD/0.6745 (11)

FIG. 7 illustrates an exemplary data table for storing the data of the noise amount. In this example, the input image noise amount σi and the normal information noise amount σn are stored for each of the plurality of noise conditions and the plurality of the light source projection angles. The noise reduction process information can be determined based on the image capturing condition (noise condition) acquired by the state detector 107 and the light source projection angle acquired in the step S102.

The format of the data table is not limited to that illustrated in FIG. 7, and may not contain the input image noise amount or may store the normal information noise amount corresponding to the object distance instead of the light source projection angle. The normal information noise amount σn and the input image noise amount σi may be acquired for each partial area (an area containing the plurality of pixels or one pixel) in the image. The step S103 may be performed next to the step S104, which will be described later.

In the step S104, the image processor 104 (normal information estimator 104a) estimates (generates) normal information using the photometric stereo method and a change of the luminance information depending on the light source position obtained from the luminance information of the plurality of image acquired in the step S101.

Next, in the step S105, the image processor 104 (noise reduction processor 104c) performs the noise reduction process for the normal information estimated in the step S104 using the normal information noise amount σn calculated in the step S103. The noise reduction process may use the noise reduction processing method for general image data. For example, a bilateral filter expressed in the following expression (12) may be used.

$$g ( i , j ) = \frac{\begin{matrix}{\sum }_{n = - w}^{w} {\sum }_{m = - w}^{w} f ( i + m , j + n ) exp ( - \frac{{m}^{2} + {n}^{2}}{2 {σ}_{1}^{2}} ) \\ exp ( - \frac{{( f ( i , j ) - f ( i + m , j + n ) )}^{2}}{2 {σ}_{2}^{2}} )\end{matrix}}{\begin{matrix}{\sum }_{n = - w}^{w} {\sum }_{m = - w}^{w} exp ( - \frac{{m}^{2} + {n}^{2}}{2 {σ}_{1}^{2}} ) \\ exp ( - \frac{{( f ( i , j ) - f ( i + m , j + n ) )}^{2}}{2 {σ}_{2}^{2}} )\end{matrix}} \qquad ( 12 )$$

In the expression (12), (i,j) is a position of the target pixel, f(i,j) is an input image, g(i,j) is an image after the noise reduction process is performed, and w is a filter size. σ₁ is a space direction diffuse value, and σ₂ is a luminance direction diffuse value. By using the normal information noise amount σn as the noise reduction process information for σ₂ (variable in the filter), this method provides the noise reduction process corresponding to the noise amount contained in the normal information and effectively reduce the influence of the noises generated when the normal information is acquired.

In this embodiment, the normal information noise amount σn becomes larger, σ₂ becomes consequently larger, and the intensity of the noise reduction process becomes higher, as the light source projection angle is smaller. In other words, the normal information noise amount σn becomes smaller, σ₂ becomes consequently smaller, and the intensity of the noise reduction process becomes lower, as the light source projection angle is larger. Thus, the normal information noise amount σn as the noise reduction process information is information used to set the intensity of the noise reduction process.

This embodiment performs the noise reduction process for the normal information, but may perform the noise reduction process for the input image. In this case, since the noise amount σi the input image itself is not the normal information noise amount σn but the input image noise amount σi, the input image noise amount σi is used for θ₂ (or the noise reduction process information). Since the normal information noise amount σn for the same input image noise amount σi has a different value depending on the light source projection angle as optical information, the noise reduction process may be performed for the input image in accordance with the normal information noise amount on by changing σ₁ in accordance with the light source projection angle. In this case, σ₁ that provides a desired noise amount may be stored as the noise reduction process information after the noise reduction process is performed for the input image noise amount σ₁ and the light source projection angle.

On the basis of the noise amount in the relighted image, the noise reduction process may be performed for the relighted image. In this case, as well as the estimation processing of the normal information, a relighted image noise amount σr is calculated which is a noise amount generated in a series of processes from the normal information to the relighted image generating process. In this case, the relighted image noise amount σr may be measured and stored in the ROM 111 for each light source condition to be relighted, similar to the normal information noise amount σn. The noise reduction process according to the noise amount contained in the relighted image can be performed by using the relighted image noise amount σr as σ₂ (or the noise reduction process information) when the noise reduction process is performed for the relighted image.

Moreover, similar to the noise reduction process for the input image according to the normal information noise amount σn, the noise reduction process may be performed for the input image or the normal information in accordance with the relighted image noise amount σr. Of course, the noise reduction process may be performed for a plurality of process targets so that the noise reduction process is performed for both the input image and the normal information.

This embodiment uses a bilateral filter for an illustrative noise reduction process method, but may use another noise reduction process method as long as the noise reduction process is performed based on the normal information noise amount σn or the relighted image noise amount σr depending on the light source information.

The input image or relighted image for which the noise reduction process is performed may not be the captured image itself. For example, it may be an image that has received image processing other than the noise reduction process, such as high resolution processing or super-resolution processing, the deconvolution process, the edge enhancement, and a Richardson-Lucy method, and a demosaic process. The image may be an image from which a reflection component is extracted, such as a specific polarization component, a diffuse reflection, and a specular reflection.

### Second Embodiment

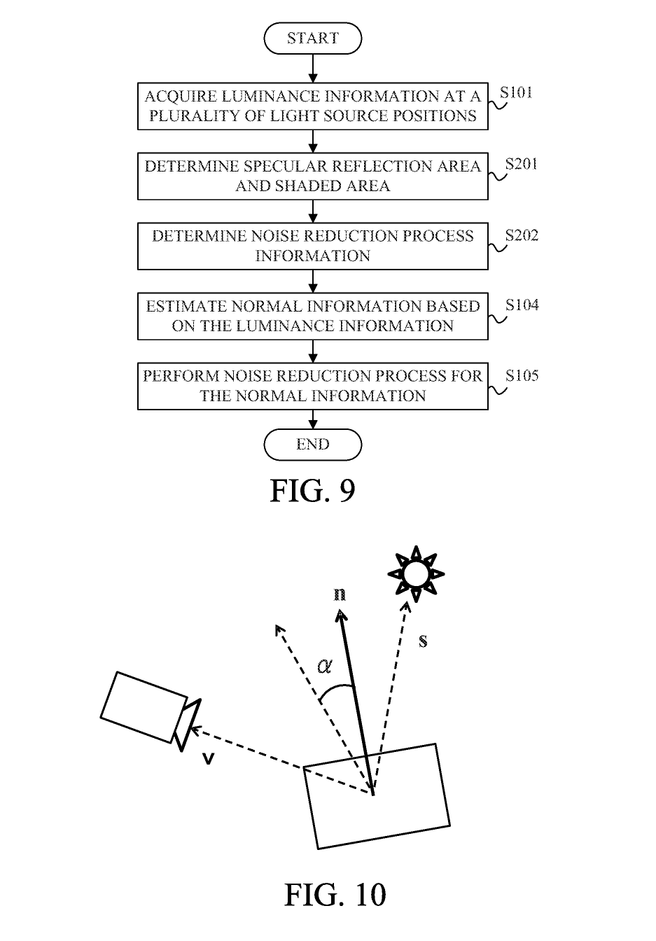

Next follows a description of a second embodiment according to the present invention. A flowchart in FIG. 9 illustrates a flow of image processing that contains the estimation process of the normal information and the noise reduction process performed by the system controller 110 and the image processor 104 in this embodiment. The configuration of the image capturing apparatus according to this embodiment is the same as that of the image capturing apparatus 300 described in the first embodiment, and the components of this embodiment common to those in the first embodiment will be designated by the same reference numerals. The image processing according to this embodiment is different from that of the first embodiment in that the image processing of this embodiment acquires the number of image (input image) used to estimate the normal information as the light source information. The steps S101, S104, and S105 are the same as the steps S101, S104, and S105 in the first embodiment (FIG. 1).

After the luminance information is acquired from the image at the plurality of light source positions in the step S101, the image processor 104 (normal information estimator 104a) determines the shaded area and the specular reflection area in each image in the step S201. As described above, in order to correctly estimate the normal information in the photometric stereo method, the luminance information of the image containing the shaded area and the specular reflection area may not be used. This method determines the number of images (referred to as “normal estimating image number” hereinafter) that can be used to estimate the normal information by excluding the image determined to contain the shaded area and the specular reflection area from all obtained images.

When the normal estimating image number is determined in the step S201, an image may be excluded in which the light and ghost appear due to the unintentional environmental light source as well as excluding the captured image containing the shaded area and the specular reflection area. In order to accelerate the estimation process of the normal information, the normal estimating image number may be intentionally reduced.

Next, in the step S202, the image processor 104 (noise reduction process information determiner 104b) determines (acquires) the noise reduction process information based on the normal estimating image number acquired in the step S201. Similar to the step S103 in the first embodiment, this embodiment previously measures and stores in the ROM 111 the normal information noise on or the relighted image noise amount σr for each normal estimating image number. Then, in determining the noise reduction process information, the noise amount corresponding to the actual normal estimating image number is acquired from the ROM 111.

Both the normal estimating image number and the light source projection angle described in the first embodiment may be used as light source information to determine the noise reduction process information. Moreover, other light source information may be used that affects the noise in the input image, such as the stability of the light source intensity.

This embodiment acquires the noise reduction process information depending on the normal estimating image number and can perform appropriate noise reduction process.

Each embodiment describes that the image processor 104 as the image processing apparatus is installed in the image capturing apparatus 300, but an image processing apparatus, such as a personal computer, separate from the image capturing apparatus may perform the image processing described in each embodiment.

Each embodiment acquires the noise reduction process information using the light source information, and can generate the normal information and the normal utilization image in which the noise influence is reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-031968, filed Feb. 23, 2016, which is hereby incorporated by reference herein in its entirety.

What is claimed is:

1. An image processing apparatus comprising:
a generator configured to acquire a plurality of input images generated by image captures under a plurality of light source conditions in which positions of light sources for illuminating an object are different from one another, and to generate surface normal information on a surface of the object using information on a change of luminance information in the input image which depends on the light source condition; and
an acquirer configured to acquire noise reduction process information as information used for a noise reduction process to the surface normal information or a process target image, using light source information as information on the light source in the image capture,
wherein the noise reduction process information contains information used to set an intensity of the noise reduction process.

2. The image processing apparatus according to claim 1, wherein the light source information contains information on a light projection direction onto the object from each light source.

3. The image processing apparatus according to claim 2, wherein the information on the light projection direction contains information on an angle between an image capturing direction from an image capturing apparatus that provides the image capture to the object, and the light projection direction or information on an angle between the light projection directions from the light sources.

4. The image processing apparatus according to claim 1, wherein the light source information contains information on the number of light source conditions.

5. The image processing apparatus according to claim 4, wherein the information on the number of light source conditions uses information on the number of input images.

6. The image processing apparatus according to claim 1, wherein the acquirer acquires the noise reduction process information for each partial area in the object.

7. The image processing apparatus according to claim 1, further comprising a processor configured to perform the noise reduction process for the surface normal information or the process target image using the noise reduction process information.

8. The image processing apparatus according to claim 1, wherein the process target image is the input image.

9. The image processing apparatus according to claim 1, wherein the process target image is a relighted image generated with the surface normal information as an image of the object under a virtual light source condition.

10. An image capturing apparatus comprising:
an image sensor configured to photoelectrically convert an optical image of an object; and
an image processing apparatus that includes:
a generator configured to acquire a plurality of input images generated by image captures under a plurality of light source conditions in which positions of light sources for illuminating an object are different from one another, and to generate surface normal information on a surface of the object using information on a change of luminance information in the input image which depends on the light source condition; and
an acquirer configured to acquire noise reduction process information as information used for a noise reduction process to the surface normal information or a process target image, using light source information as information on the light source in the image capture,
wherein the noise reduction process information contains information used to set an intensity of the noise reduction process, and
wherein the image processing apparatus acquires as the input images, captured images generated with an output from the image sensor.

11. The image capturing apparatus according to claim 10, wherein the image processing apparatus calculates information on a distance to the object using a signal obtained as a result of that mutually different pixels in the image sensor photoelectrically convert a plurality of light fluxes that have passed mutually different areas in a pupil in an image capturing optical system, and to acquire the light source information based on the information on the distance.

12. An image processing program as a computer program configured to enable a computer to execute a method that includes the steps of:
acquiring a plurality of input images generated by image captures under a plurality of light source conditions in which positions of light sources for illuminating an object are different from one another, and generating surface normal information on a surface of the object using information on a change of luminance information in the input image which depends on the light source condition; and
acquiring noise reduction process information as information used for a noise reduction process to the surface normal information or a process target image, using light source information as information on the light source in the image capture,
wherein the noise reduction process information contains information used to set an intensity of the noise reduction process.

13. An image processing program according to claim 12, wherein the method further includes the step of performing the noise reduction process for the surface normal information or the process target image, using the noise reduction process information.
